(19) United States
(12) Patent Application Publication
(10) Pub. No.: US 2021/0310231 A1
(43) Pub. Date: Oct. 7, 2021

(54) CABLE COUNTER FOR A SEWER CLEANING MACHINE

(71) Applicant: MILWAUKEE ELECTRIC TOOL CORPORATION, Brookfield, WI (US)

(72) Inventors: Alex R. Kuhls, Menomonee Falls, WI (US); Luke J. Skinner, West Bend, WI (US); Carl B. Westerby, Menomonee Falls, WI (US)

(21) Appl. No.: 17/224,614

(22) Filed: Apr. 7, 2021

Related U.S. Application Data
(60) Provisional application No. 63/006,211, filed on Apr. 7, 2020.

(51) Int. Cl. E03F 9/00; G06K 7/10

(52) U.S. Cl. CPC E03F 9/005; G06K 7/10386; G06K 7/10445

(57) ABSTRACT

A sewer cleaning machine includes a frame and a drum rotatably supported by the frame. The drum defines an opening. The sewer cleaning machine also includes a cable supported within the drum and is operable to enter and exit the drum through the opening. The cable includes a plurality of tags spaced along a length of the cable. The sewer cleaning machine further includes a reader module positioned adjacent the opening. The reader module is operable to identify each of the plurality of tags as the plurality of tags passes the reader module and communicate to a user a distance the cable is payed out of the drum based on the plurality of tags.

### CROSS REFERENCE TO RELATED APPLICATION

This application claims the benefit of co-pending U.S. Provisional Patent Application Ser. No. 63/006,211, filed on Apr. 7, 2020, the entire contents of which are incorporated by reference herein.

### BACKGROUND

The present invention relates to a cable counter for cables that are used with sewer cleaning machines or for televising sewer lines or other conduits.

Sewer cleaning machines are used to clean clogs and debris out of drains, sewers, and the like. Sewer cleaning machines have a preset length of cable. Accordingly, knowing the distance the cable is payed out may be beneficial.

### SUMMARY

The invention provides, in one aspect, a sewer cleaning machine including a frame and a drum rotatably supported by the frame. The drum defines an opening. The sewer cleaning machine also includes a cable supported within the drum and is operable to enter and exit the drum through the opening. The cable includes a plurality of tags spaced along a length of the cable. The sewer cleaning machine further includes a reader module positioned adjacent the opening. The reader module is operable to identify each of the plurality of tags as the plurality of tags passes the reader module and communicate to a user a distance the cable is payed out of the drum based on the plurality of tags.

The invention provides, in another aspect, a cable counter for a sewer cleaning machine including a drum. The cable counter includes a cable with a plurality of tags spaced along a length of the cable. Each tag includes a unique identification code. The cable counter also includes a reader module operable to identify each tag of the plurality of tags. The reader module includes an antenna to detect each tag of the plurality of tags as the cable passes the antenna, a tag reader in communication with the antenna to determine the unique identification code of each tag of the plurality of tags, a processor in communication with the tag reader to compare the unique identification code of each tag of the plurality of tags to unique identification codes stored within a memory of the processor, and a display in communication with the processor to display information associated with the unique identification code of each tag of the plurality of tags to a user.

The present provides, in another aspect, a method of operating a sewer cleaning machine. The sewer cleaning machine includes a drum having an opening, a cable supported within the drum and having a tag with a unique identification code, and a reader module supported adjacent the opening. The method includes moving the cable relative to the drum through the opening, sensing, by an antenna of the reader module, the tag as the tag passes the reader module, determining, by a tag reader of the reader module, the unique identification code of the tag sensed by the antenna, comparing, by a processor of the reader module, the unique identification code of the tag with unique identification codes stored within a memory of the processor, and displaying, by a display, information associated with the unique identification code of the tag to a user.

### BRIEF DESCRIPTION OF THE DRAWINGS

FIG. 1 is a front perspective view of a sewer cleaning machine.

FIG. 2 is a front perspective of a portion of the sewer cleaning machine of FIG. 1 including a cable counter.

FIG. 3 is a perspective view of the portion of the sewer cleaning machine of FIG. 1 with a cable partially payed out through the cable counter.

FIG. 4 is a block diagram of the sewer cleaning machine of FIG. 1.

FIG. 5 is a flowchart depicting a method of operating the sewer cleaning machine of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

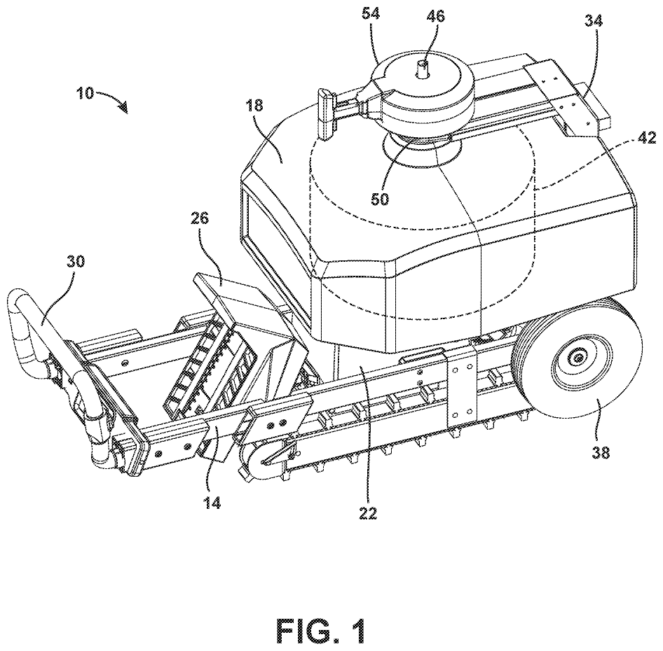

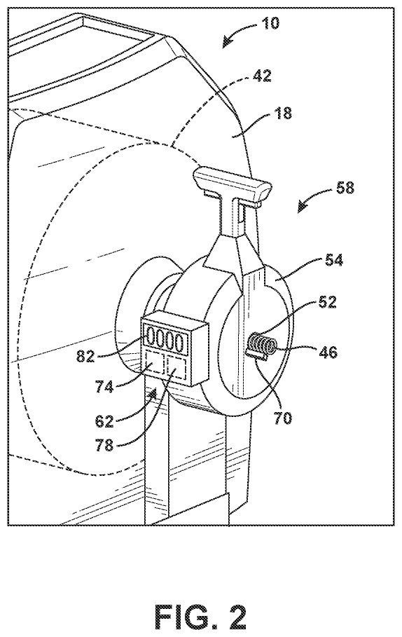

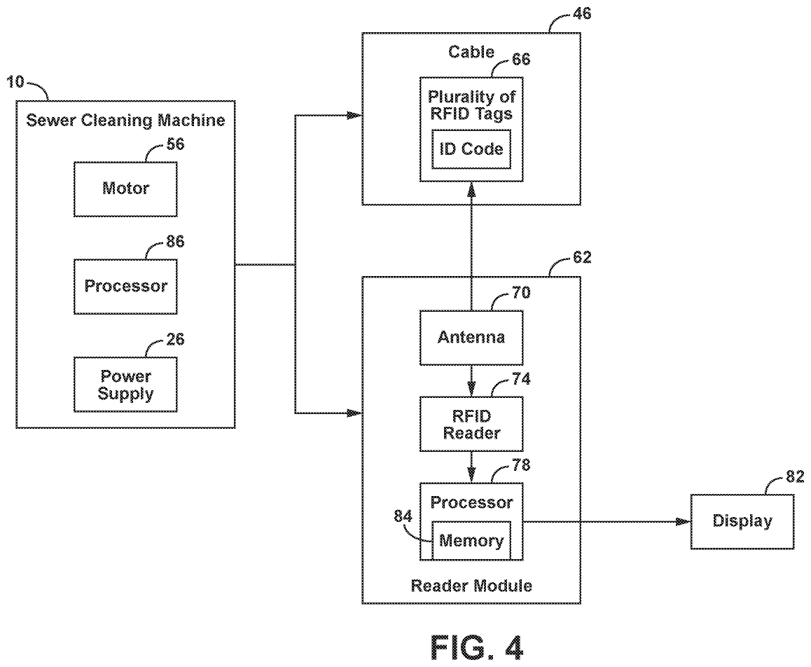

FIG. 1 illustrates a sewer cleaning machine 10 including a frame 14, a drum housing 18, a motor housing 22, and a power supply 26. The frame 14 includes a handle 30, a base 34 that supports the drum housing 18, and wheels 38. A drum 42 is rotatably supported within the drum housing 18 and includes a cable 46 that is extendable out of an opening 50 on the drum 42. In some embodiments, the drum 42 is a cage-style drum that when the drum housing 18 is opened allows easy access to the cable 46 so a user can inspect the cable 46. In the illustrated embodiment, the cable 46 is extendable out of the opening 50 of the drum 42 with a cable feed device 54 through an opening 52 of the cable feed device 54 (FIG. 2). In other embodiments, the sewer cleaning machine 10 may not include the cable feed device 54. A motor 56 (FIG. 4)) is supported within the motor housing 22 and is coupled to the drum 42. The motor is powered by the power supply 26 that is supported on the frame 14. The motor may be a brushless motor or a variable speed motor. The motor 56 is operable to rotate the drum 42. Rotation of the drum 42 creates friction between an inner surface of the drum 42 and the cable 46, which causes the cable 46 to spin to facilitate clearing debris from a drain pipe or another conduit. The cable feed device 54 can also selectively engage the spinning cable 46 to drive the cable 46 out of or into the drum 42.

In the illustrated embodiment, the power supply 26 includes a battery receptacle that receives a battery pack to provide D/C power to the sewer cleaning machine 10. For example, the battery receptacle may removably receive a rechargeable power tool battery pack. In further embodiments, the power supply 26 may receive more than one battery pack to power the sewer cleaning machine 10. In alternative embodiments, the power supply 26 may be coupled to a power outlet to provide A/C power to the sewer cleaning machine 10.

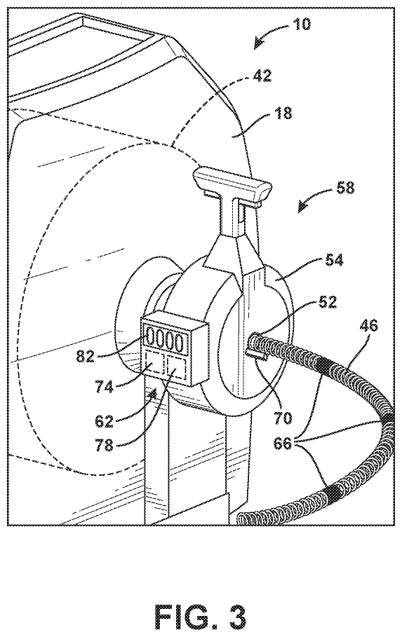

FIGS. 2 and 3 illustrate a cable counter 58 for the sewer cleaning machine 10. In other embodiments, the cable counter 58 may be operable with drain snakes, drain cleaners, hand-held drain cleaners, or the like. The cable counter 58 is capable of determining the amount of the cable 46 that enters or exits through the opening 52 of the cable feed device 54. The cable counter 58 includes the cable 46 and a reader module 62.

With reference to FIG. 3, the cable 46 includes a plurality of transmitters. The illustrated transmitters are wireless transmitters, such as radio frequency identification (RFID) tags 66 or other near field communication (NFC) type tags. The tags 66 are spaced in intervals along the length of the cable 46. In the illustrated embodiment, the tags 66 are spaced in one foot increments. In other embodiments, the tags 66 may be spaced in increments that are greater than a foot or less than a foot. In further embodiments, the tags 66 may be spaced in unequal increments. The tags 66 may be attached on the outside of the cable 46 or positioned within the cable 46. For example, the cable 46 may be composed of a metal (e.g., stainless steel) wire that is wound in a coil, and the tags 66 may be positioned within the coil.

Each tag 66 includes a different unique ID code. The RFID tags 66 are positioned at specific positions along the length of the cable 46. These specific positions can be correlated to a distance that the cable 46 is payed out of the opening 50 in the drum 42 or a distance the cable 46 is payed out of the opening 52 in the cable feed device 54. The specific positions can also be correlated to a distance that the cable is retracted through the opening 50 in the drum 42 or the opening 52 in the cable feed device 54. Specifically, the ID code communicates a footage correlating to the amount of the cable 46 payed out of or retracted into the drum 42 to the reader module 62.

Referring to FIG. 2, the reader module 62 is positioned adjacent the opening 52 of the cable feed device 54 and is supported by the cable feed device 54. In other embodiments, the reader module 62 may be positioned elsewhere on the sewer cleaning machine 10. For example, in embodiments where the cable feed device 54 is omitted, the reader module 62 may be positioned on the drum 42 or the drum housing 18, adjacent the opening 50 in the drum 42 and/or the drum housing 18. The illustrated reader module 62 includes an antenna 70, a RFID reader 74, a processor 78, and a display 82. The antenna 70 is able to detect the radio frequency of an ID code of a tag 66 of the cable 46 when the tag 66 is in close proximity to the antenna 70. In other words, the antenna 70 detects a tag 66 as it passes the antenna 70 while the cable 46 is being extended or retracted from the opening 52. The RFID reader 74 is in communication with the antenna 70 to then determine the ID code of the specific tag 66 that passes by the antenna 70. The RFID reader 74 communicates the detected ID code to the processor 78. Before operation of the sewer cleaning machine 10, each ID code of each tag 66 is read by the reader module 62 and stored in a memory 84 (FIG. 4) of the processor 78 before the tag 66 is installed in the cable 46. In other embodiments, the ID codes of the tags 66 may be entered into the memory 84 during manufacture of the sewer cleaning machine 10 or by a user. In some embodiments, the ID codes of the tags 66 may be downloaded into the memory 84 from a database.

In some embodiments, the processor 78 is implemented as a microprocessor with separate memory, such as the memory 84. In other embodiments, the processor 78 may be implemented as a microcontroller (with memory 84 on the same chip). In other embodiments, the electronic processor 78 may be implemented using multiple processors. In addition, the electronic processor 78 may be implemented partially or entirely as, for example, a field-programmable gate array (FPGA), an applications specific integrated circuit (ASIC), and the like, and the memory 84 may not be needed or be modified accordingly. In the example illustrated, the memory 84 includes non-transitory, computer-readable memory that stores instructions and data that are received and executed by the processor 78 to carry out the functionality of the reader module 62. The memory 84 may include, for example, a program storage area and a data storage area. The program storage area and the data storage area may include combinations of different types of memory, such as read-only memory and random-access memory.

The display 82 is operable to communicate to a user the specific distance the cable 46 is payed out of the drum 42. In the illustrated embodiment, the display 82 is part of the reader module 62 supported on sewer cleaning machine 10. In other embodiments, the display 82 may also or alternatively be part of a remote device, such as a user's smartphone. The display 82 may display the amount of cable currently payed out from the drum 42 in different units, such as feet or meters. Alternatively, the display 82 may display the amount of cable remaining in the drum 42. A user may also adjust the display 82 to switch between different modes, such as units of measurements, amount of cable payed out from or amount of cable remaining in the drum 42, and the like. The illustrated display 82 is an LED or LCD screen operable to display digits associated with the amount of cable. In other embodiments, the display 82 may display other types of indicia (e.g., graphics, colors, etc.) associated with the cable. In some embodiments, a user may reset or zero out the display so that the amount of cable previously payed out is not factored into the total amount of payed out cable.

During operation of the sewer cleaning machine 10, the cable feed device 54 or a user may extend or retract the cable 46 from the drum 42. As the cable 46 is fed or pulled out of the drum 42, the antenna 70 reads each ID code of each tag 66 as the tag 66 passes the antenna 70. As mentioned, each tag 66 has a unique ID code that correlates to a specific distance the cable 46 is extended from the drum 42. As the tags 66 pass the antenna 70, the antenna 70 communicates with the RFID reader 74 to determine the specific ID code of the tag 66. The RFID reader 74 then communicates the detected ID code to the processor 78. The processor 78 compares the detected ID code with the ID codes stored in the memory 84. If the ID code of the passing tag 66 matches an ID code stored in the memory 84, the processor 78 communicates with the display 82 to display the footage associated with the ID code of the specific tag 66. As the cable 46 continues to be extended or retracted, the RFID reader 74 continually checks for new ID codes from the tags 66 and the display 82 is updated when a new tag 66 is discovered.

In some embodiments, the ID codes of the tags 66 may include additional information such as type of cable (e.g., metal, plastic, wind, etc.), cable size (e.g., diameter, weight, etc.), and the like. The ID codes would then communicate with the reader module 62 to display the additional information. In other embodiments, the processor 78 may be able to determine whether the cable 46 is being extended or retracted from the drum 42 based on whether a particular tag 66 was read previously. For example, the processor 78 would know if the cable 46 was being extended if the RFID reader 74 detected the ID code associated with “2 feet” prior to detecting the ID code associated with “3 feet.” In further embodiments, the reader module 62 may include a wireless communication device. The wireless communication device may be operable to communicate the distance the cable 46 is payed out with another wireless communication device within a remote device (e.g., a smart phone).

With reference to FIG. 4, the sewer cleaning machine 10 includes the motor 56 that rotates the drum 42, the power supply 26, and a processor 86 that controls operation of the sewer cleaning machine 10. The cable 46 is supported by the sewer cleaning machine 10 and includes the plurality of RFID tags 66. Each tag 66 includes a unique ID code that correlates to a specific distance. The reader module 62 includes the antenna 70 that is constantly scanning for an RFID tag 66, the RFID reader 74, and the processor 78. As mentioned, the processor 78 compares ID codes to ID codes stored in the memory 84. If the scanned ID code matches an ID code stored in the memory 84 of the processor 78, the processor 78 communicates to the display 82 to display the distance associated with that ID code.

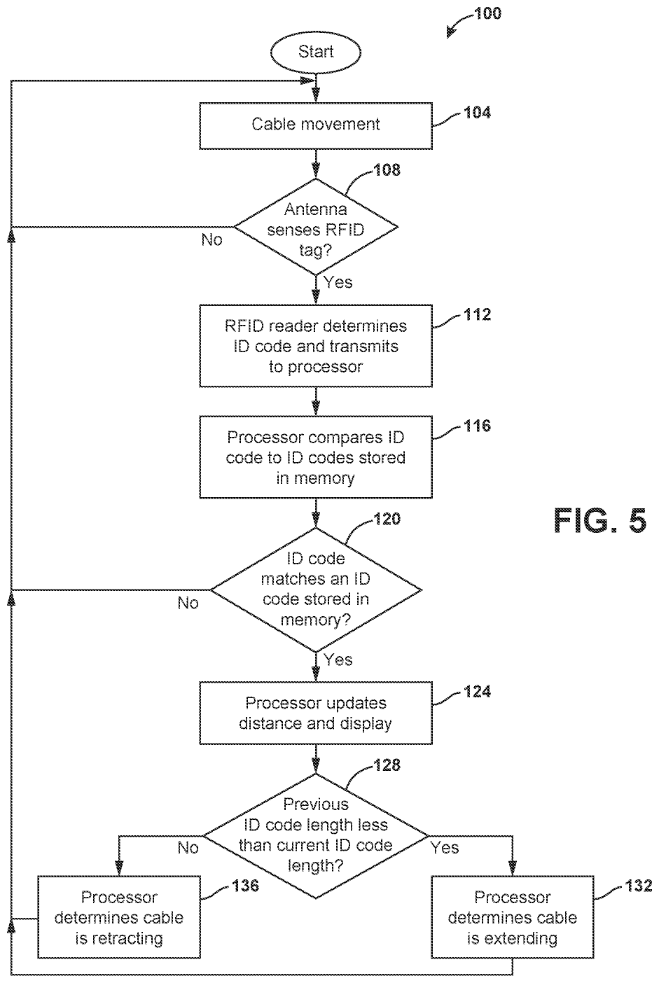

FIG. 5 depicts a method 100 of operating the sewer cleaning machine 10. Although the method 100 includes specific steps, all of the steps need not be performed or be performed in the order shown and described.

At step 104, the cable 46 is moved out of or into the drum 42 by a user and/or the cable feed device 54. For example, a user may manually pull the cable 46 out of the drum 42. Alternatively, the user may activate the cable feed device 54 to automatically pay the cable 46 out of the drum 42 or feed the cable 46 into the drum 42. As the cable 46 moves, the antenna 70 continuously scans the cable 46 for RFID tags 66 at step 108.

If the antenna 70 senses a RFID tag 66 at step 108, the antenna 70 communicates the tag 66 information to the RFID reader 74 at step 112. The RFID reader 74 determines the ID code associated with the tag 66 at step 116. Once the ID code is determined, at step 120, the processor 78 compares the scanned ID code to the ID codes stored in the memory 84. If the ID code matches an ID code stored in the memory 84, the processor 78 communicates to the display 82 to display the distance associated with the specific ID code of the RFID tag 66 at step 124.

At step 128, the processor 78 compares the currently-detected ID code to the previously-detected ID code. If the previously-detected ID code's associated length is less than the currently scanned ID code's associated length, the processor 78 determines that the cable 46 is being extended from the opening 52 at step 132. Alternatively, if the previously-detected ID code's associated length is greater than the currently-detected ID code's associated length, the processor 78 determines that the cable 46 is being retracted from the opening 52 at step 136. The processor 78 may send a signal to the display 82 for the display 82 to also display the direction of cable movement (e.g., into or out of the drum 42). The direction of cable movement may be displayed with, for example, a word or arrow. The process continues while the cable 46 is moving axially through the opening 52.

Various features and advantages are set forth in the following claims

What is claimed is:

1. A sewer cleaning machine comprising:
a frame;
a drum rotatably supported by the frame, the drum defining an opening;
a cable supported within the drum and operable to enter and exit the drum through the opening, the cable including a plurality of tags spaced along a length of the cable; and
a reader module positioned adjacent the opening, the reader module operable to identify each of the plurality of tags as the plurality of tags passes the reader module and communicate to a user a distance the cable is payed out of the drum based on the plurality of tags.

2. The sewer cleaning machine of claim 1, further comprising:
a motor supported by the frame and coupled to the drum to rotate the drum; and
a power supply operable to energize the motor to rotate the drum.

3. The sewer cleaning machine of claim 2, wherein the power supply is a removable battery pack.

4. The sewer cleaning machine of claim 1, wherein each tag of the plurality of tags is a radio frequency identification tag.

5. The sewer cleaning machine of claim 1, wherein each tag of the plurality of tags includes a unique identification code.

6. The sewer cleaning machine of claim 5, wherein each unique identification code is associated with a distance on the cable.

7. The sewer cleaning machine of claim 1, wherein the plurality of tags is spaced at equal intervals along the length of the cable.

8. The sewer cleaning machine of claim 7, wherein each tag of the plurality of tags is spaced one foot relative to an adjacent tag of the plurality of tags.

9. The sewer cleaning machine of claim 1, wherein the reader module includes a display operable to display the distance the cable is payed out of the drum.

10. A cable counter for a sewer cleaning machine including a drum, the cable counter comprising:
a cable including a plurality of tags spaced along a length of the cable, each tag including a unique identification code; and
a reader module operable to identify each tag of the plurality of tags, the reader module including
an antenna to detect each tag of the plurality of tags as the cable passes the antenna,
a tag reader in communication with the antenna to determine the unique identification code of each tag of the plurality of tags,
a processor in communication with the tag reader to compare the unique identification code of each tag of the plurality of tags to unique identification codes stored within a memory of the processor, and
a display in communication with the processor to display information associated with the unique identification code of each tag of the plurality of tags to a user.

11. The cable counter of claim 10, wherein the plurality of tags is spaced at equal intervals along the length of the cable.

12. The cable counter of claim 10, wherein the information associated with the unique identification code of each tag of the plurality of tags includes the distance the cable is payed out from the drum.

13. The cable counter of claim 10, wherein the information associated with the unique identification code of each tag of the plurality of tags includes a size of the cable.

14. The cable counter of claim 10, wherein the information associated with the unique identification code of each tag of the plurality of tags includes a type of cable.

15. A method of operating a sewer cleaning machine, the sewer cleaning machine including a drum having an opening, a cable supported within the drum and having a tag with a unique identification code, and a reader module supported adjacent the opening, the method comprising:
moving the cable relative to the drum through the opening;
sensing, by an antenna of the reader module, the tag as the tag passes the reader module;
determining, by a tag reader of the reader module, the unique identification code of the tag sensed by the antenna;
comparing, by a processor of the reader module, the unique identification code of the tag with unique identification codes stored within a memory of the processor; and
displaying, by a display, information associated with the unique identification code of the tag to a user.

16. The method of claim 15, wherein the tag is one of a plurality of tags spaced along a length of the cable.

17. The method of claim 16, further comprising determining, by the processor, a direction of movement of the cable by comparing a unique identification code of a previously detected tag of the plurality of tags with the unique identification code of the currently detected tag of the plurality of tags.

18. The method of claim 17, further comprising communicating, by the display, the direction of movement of the cable to the user.

19. The method of claim 15, wherein the information associated with the unique identification code of the tag includes a distance the cable is payed out from the drum.

20. The method of claim 15, wherein the display is part of the reader module.
